(19) United States
(12) Patent Application Publication
(10) Pub. No.: US 2004/0058587 A1
(43) Pub. Date: Mar. 25, 2004

(54) Wire connecting section of plug conducting terminal

(76) Inventor: Chyong-Yen Huang, Taipei City (TW)

Correspondence Address: Atom Technology Inc., P.O. Box No. 6-57, Junghe, Taipei 235, TW

(21) Appl. No.: 10/655,068

(22) Filed: Sep. 5, 2003

(30) Foreign Application Priority Data
Sep. 23, 2002 (TW) 091214946

(51) Int. Cl. H01R 4/10

(52) U.S. Cl. 439/877

(57) ABSTRACT

A wire connecting section of plug conducting terminal includes a wire connecting section at a tip of a conducting terminal, wherein the wire connecting section is provided with open portions in different shapes and quantities. When a core terminal of a power line is clamped and fastened at the wire connecting section, the open portions at the wire connecting terminal allow molten solder to rapidly seep through, thereby securely welding and joining the wire connecting section with the core terminal of the power line. Using the aforesaid structure, false-welding and accompanied shortcomings as disengagement of the core terminal, and poor contact and conductivity are prevented, while accomplishing objects as economizing materials and lowering production costs.

### BACKGROUND OF THE INVENTION

(a) Field of the Invention

The invention relates to a wire connecting section of plug conducting terminal, and more particularly, to a wire connecting section having open portions in different shapes and quantities. The open portions allow molten solder to rapidly seep through, so as to securely weld and join the wire connecting section with a core terminal of a power line. Thus, false-welding and accompanied shortcomings as disengagement of the core terminal, and poor contact and conductivity are prevented.

(b) Description of the Prior Art

Referring to FIG. 8 showing a common wire plug of an electric appliance, an interior of the prior wire plug comprises a plate-like conducting terminal A, and a curled wire connecting section B. The wire connecting section B is for wrapping around a core terminal D of a power line C. Using appropriate processing tools, the wire connecting section B is pressed inward for clamping, such that the core terminal D of the power line C is fastened in the wire connecting section B as shown in FIG. 9. However, for that the core terminal D of the power line C is clamped merely by a small area of the wire connecting section B, clasping forces thereof are somewhat insufficient. Poor contact or even disengagement of the core terminal D is easily resulted to further affect due conducting efficiency. Therefore, in order to reinforce clasping forces of the wire connecting section B, welding means is applied to outer edges of a contact portion of the wire connecting section B and the core terminal D. Molten solder E is utilized for welding and is seeped between the wire connecting section B and the core terminal D. The wire connecting section B and the core terminal D are then welded and set into one body when the solder E is cooled and solidified, thereby reinforcing clasping forces of the wire connecting section B to prevent disengagement of the core terminal D. Nevertheless, for that the contact portion of the wire connecting section B and the core terminal D is quite compact and the molten solder E has relatively poor mobility, the molten solder E is unlikely to be totally seeped between the wire connecting wire B and the core terminal D for accomplishing welding and fastening purposes. Referring to FIG. 10, only surfaces of the wire connecting wire B are welded, with a so-called “false-welding” result formed. Similarly, apart from disengagement of the core terminal due to imperfect fastening, false-welding also likely leads to poor contact and conductivity. These shortcomings are only discovered by consumers after certain periods of use. Substantial complaints are filed by consumers, and series affects with respect to prestige of sellers also become unavoidable. To prevent such shortcomings, it is essential that manual inspections be carried out to detect defectives having false-welding. However, this countermeasure consumes both manpower and material resources, with production costs being indirectly increased. Also, manual inspections do not promise 100% yield rate, and particular defectives remain undiscovered and are circulated to consumer ends. Hence, it is repeated occurrences that consumers who have purchased the detectives file complaints while causing agony to all.

### SUMMARY OF THE INVENTION

The object of the invention is to provide a wire connecting section for plug conducting terminal, in that the a wire connecting section is capable of preventing disengagement of a core terminal and accompanied poor contact and conductivity, as well as economizing materials for lowering production costs.

The wire connecting section for plug conducting terminal according to the invention comprises a wire connecting section at a tip of a conducting terminal, wherein the wire connecting section is provided with open portions in different shapes and quantities. When a core terminal of a power line is clamped and fastened at the wire connecting section, the open portions at the wire connecting terminal allow molten solder to rapidly seep through, thereby securely welding and joining the wire connecting section with the core terminal of the power line.

### BRIEF DESCRIPTION OF THE DRAWINGS

FIG. 1 shows a structural elevational view according to the invention.

FIG. 2 shows an elevational view according to the invention.

FIG. 3 shows a sectional view illustrating completed welding according to the invention.

FIG. 4 shows a structural elevational view illustrating another embodiment according to the invention.

FIG. 5 shows a sectional view illustrating completed welding of another embodiment according to the invention.

FIG. 6 shows a structural elevational view illustrating yet another embodiment according to the invention.

FIG. 7 shows a sectional view illustrating completed welding of yet another embodiment according to the invention.

FIG. 8 shows a conventional structural elevational view of a prior conducting terminal.

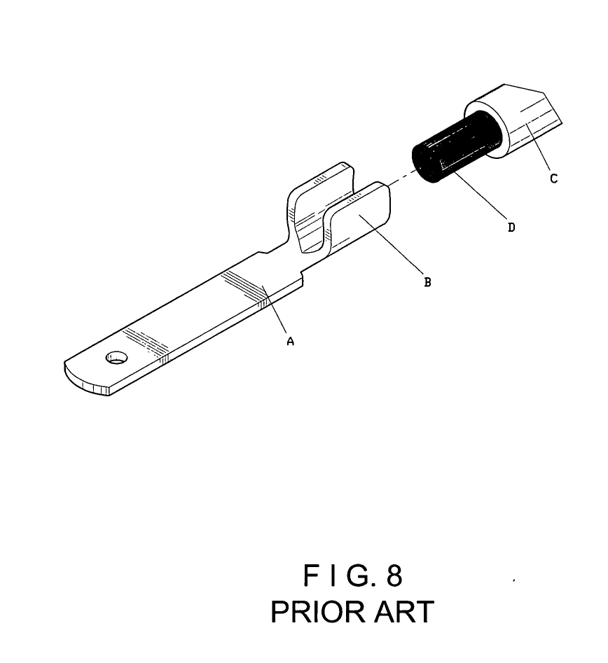

FIG. 9 shows a conventional elevational view of a prior conducting terminal.

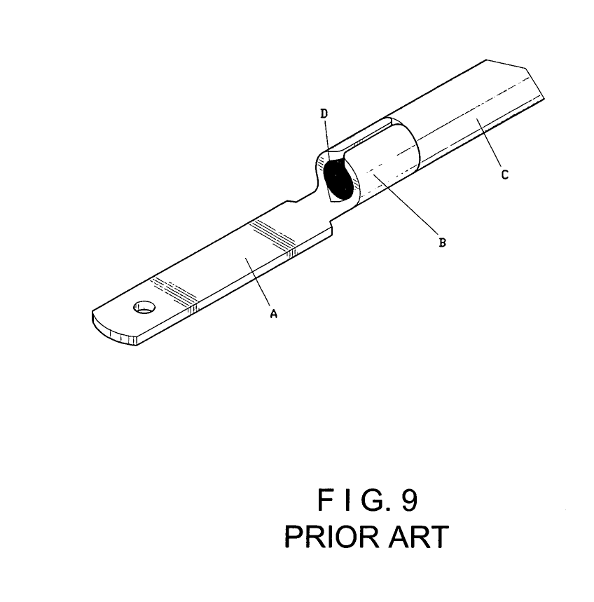

FIG. 10 shows a conventional sectional view illustrating completed welding of a prior conducting terminal.

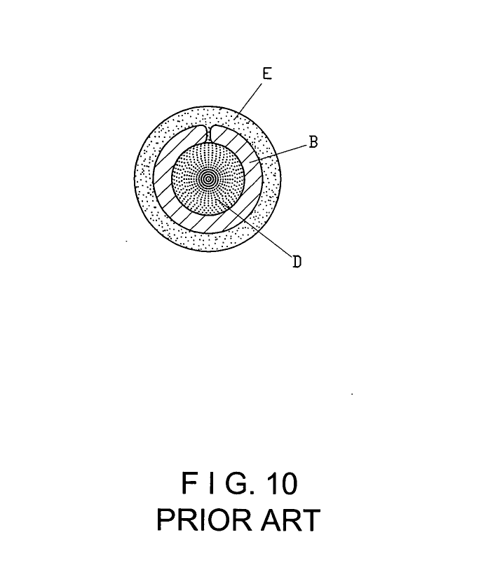

### DETAILED DESCRIPTION OF THE PREFERRED EMBODIMENTS

To better understand the invention, detailed descriptions shall be given with the accompanying drawings below.

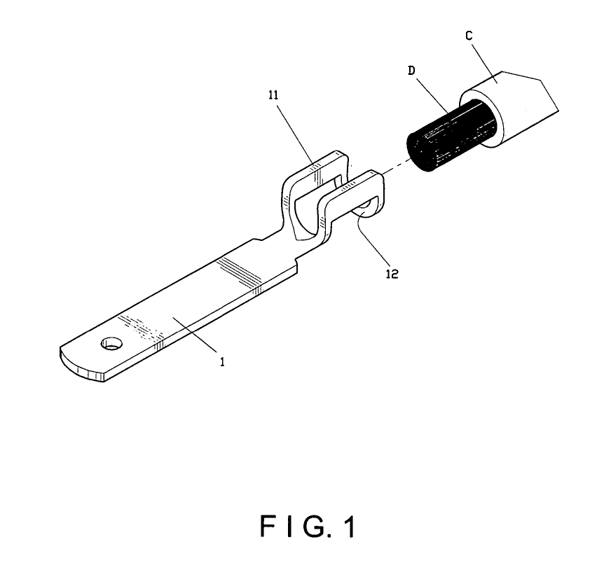

Referring to FIG. 1, according to the invention, a plate-like conducting terminal 1 comprises a connected wire connecting section 11 at a tip thereof, wherein the conducting terminal 11 is provided with a rectangular open portion 12.

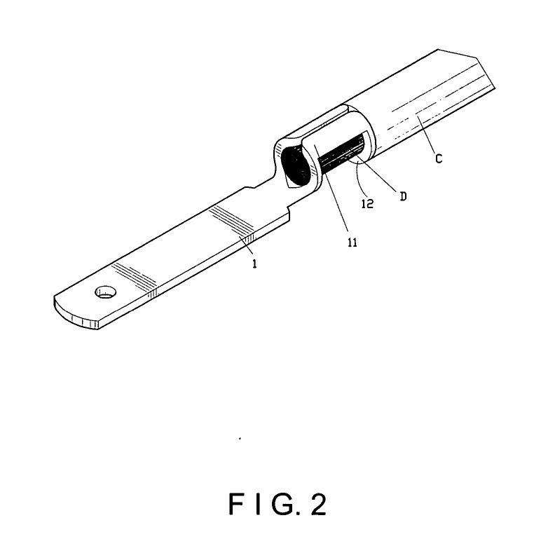

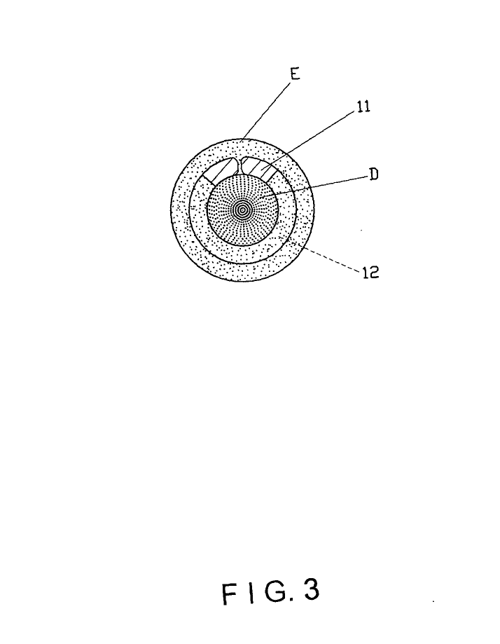

Referring to FIG. 2, for assembly, a core terminal D of a power line C is placed at inner edges of the wire connecting section 11. Using appropriate processing tools, the wire connecting section 11 is pressed inward and clamped, such that the core terminal D of the power line C becomes fastened at the inner edges of the wire connecting section 11. Welding means is applied to outer edges of a contact portion of the wire connecting section 11 and the core terminal D. Molten solder E is utilized for welding, and, after coming into contact with front and rear ends and the open portion 12 via the wire connecting section 11 and the core terminal D, is rapidly and completely seeped between wire connecting section 11 and the core terminal D in a direct manner as shown in FIG. 3. The wire connecting section 11 and the core terminal D are then welded and set into one body when the solder E is cooled and solidified. Without resulting in shortcomings as being easily disengaged and causing poor contact and conductivity by “false-welding”, clasping forces of the wire connecting section 11 are reinforced to prevent disengagement of the core terminal D. Moreover, for that the wire connecting terminal 11 is provided with the open portion 12, material needed for production of the conducting terminal 1 is reduced for further lowering production costs.

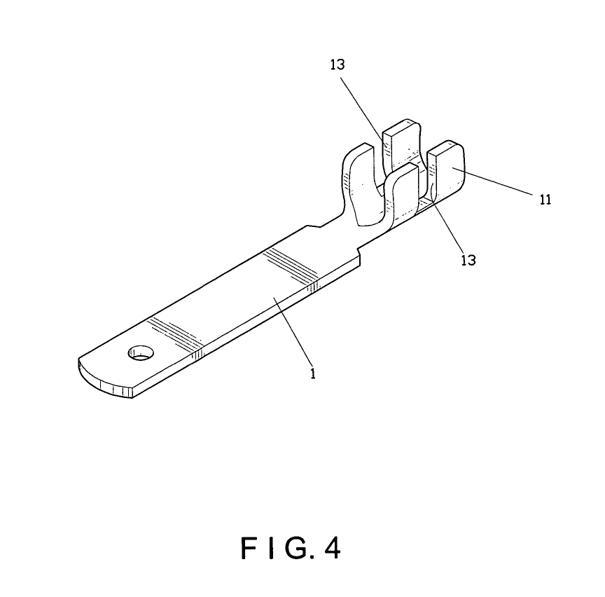

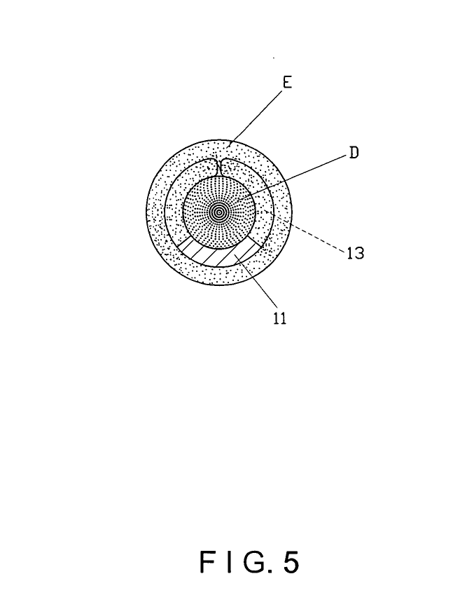

Referring to FIG. 4 showing another embodiment according to the invention, the conducting terminal 1 has a curled wire connecting section 11 at a tip thereof, wherein the wire connecting section 11 is provided with a square open portion 13 at two sides thereof, respectively. For assembly, the core terminal D of the power line C is placed at inner edges of the wire connecting terminal 11. Using appropriate processing tools, the wire connecting section 11 are pressed inward and clamped, such that the core terminal D of the power line C becomes fastened at the inner edges of the wire connecting section 11. Welding means is applied to outer edges of a contact portion of the wire connecting section 11 and the core terminal D. Molten solder E is utilized for welding, and, after coming into contact with front and rear ends and the open portions 13 via the wire connecting section 11 and the core terminal D, is rapidly and completely seeped between wire connecting section 11 and the core terminal D in a direct manner as shown in FIG. 5. The wire connecting section 11 and the core terminal D are then welded and set into one body when the solder E is cooled and solidified. Without resulting in shortcomings as being easily disengaged and causing poor contact and conductivity by “false-welding”, clasping forces of the wire connecting section 11 are reinforced to prevent disengagement of the core terminal D.

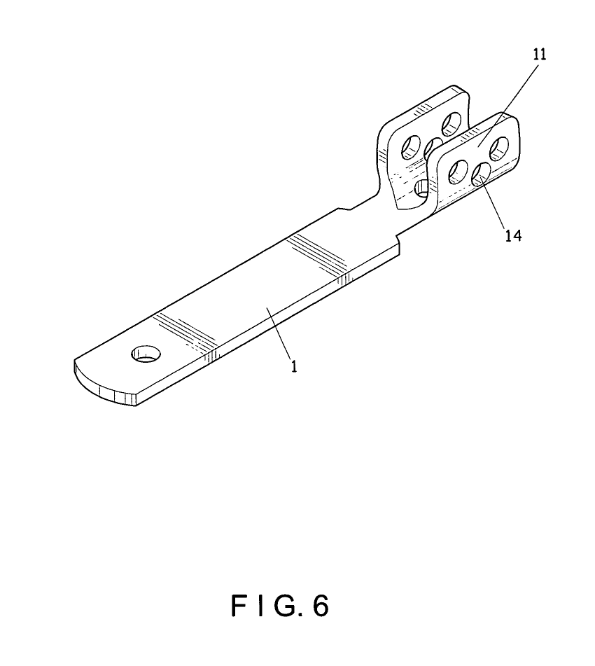

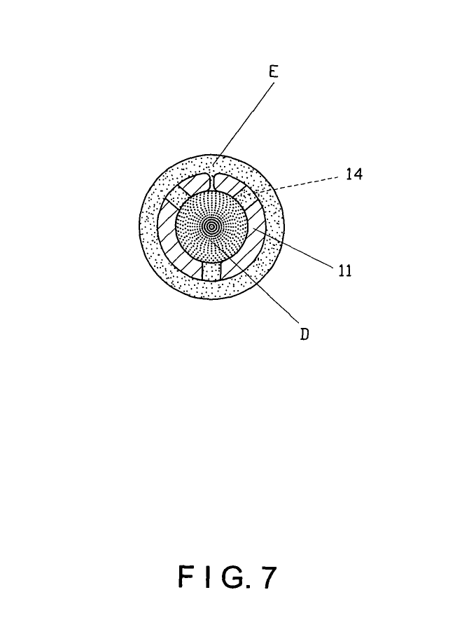

Referring to FIG. 6 showing yet another embodiment according to the invention, the conducting terminal 1 has a curled wire connecting section 11 at a tip thereof, wherein the wire connecting section 11 is provided with a plurality of round open portions 14 at two sides thereof, respectively. For assembly, the core terminal D of the power line C is placed at inner edges of the wire connecting terminal 11. Using appropriate processing tools, the wire connecting section 11 are pressed inward and clamped, such that the core terminal D of the power line C becomes fastened at the inner edges of the wire connecting section 11. Welding means is applied to outer edges of a contact portion of the wire connecting section 11 and the core terminal D. Molten solder E is utilized for welding, and, after coming into contact with front and rear ends and the open portions 13 via the wire connecting section 11 and the core terminal D, is rapidly and completely seeped between wire connecting section 11 and the core terminal D is a direct manner as shown in FIG. 7. The wire connecting section 11 and the core terminal D are then welded and set into one body when the solder E is cooled and solidified. Without resulting in shortcomings as being easily disengaged and causing poor contact and conductivity by “false-welding”, clasping forces of the wire connecting section 11 are reinforced to prevent disengagement of the core terminal D.

Conclusive from the above, the invention has the following excellences when put to use:

1. According to the invention, the wire connecting section of the conducting terminal is provided with open portions. Using the open portions, molten solder is allowed to rapidly seep through to securely weld and join the wire connecting section with the core terminal of the power line. Therefore, false-welding is prevented to further avoid shortcomings as disengagement, poor contact and conductivity of the core terminal.

2. Owing to the open portions provided at the wire connecting section of the conducting terminal, manufacturing material of the conducting terminal is economized for lowering production costs while obtaining optimal manufacturing quality.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A wire connecting section of plug conducting terminal comprising a wire connecting section at a tip of a conducting terminal; wherein the wire connecting terminal is for clamping and fastening a core terminal, and is provided with at least one open portion, via which molten solder is seeped through from an exterior of the open portion into the core terminal of a power line.
